(19) United States
(12) Patent Application Publication
(10) Pub. No.: US 2025/0132071 A1
(43) Pub. Date: Apr. 24, 2025

(54) COMMUNICATION CABLES WITH ELECTRICAL AND OPTICAL LANES

(71) Applicant: Panduit Corp., Tinley Park, IL (US)

(72) Inventors: Jose M. Castro, Naperville, IL (US); Bulent Kose, Burr Ridge, IL (US); Paul W. Wachtel, Arlington Heights, IL (US); Yu Huang, Orland Park, IL (US); Brian L. Kelly, Oak Forest, IL (US); George F. Einterz, Schererville, IN (US); Kevin A. Marley, Joliet, IL (US)

(73) Assignee: Panduit Corp., Tinley Park, IL (US)

(21) Appl. No.: 18/886,513

(22) Filed: Sep. 16, 2024

Related U.S. Application Data
(60) Provisional application No. 63/545,251, filed on Oct. 23, 2023.

(51) Int. Cl. H01B 11/08; H01B 11/22

(52) U.S. Cl. CPC H01B 11/08; H01B 11/22

(57) ABSTRACT

A hybrid cable designed for providing data communications via both optical fiber and copper wires is provided. The hybrid cable includes internal features for designing a location of the optical fiber and the copper wires relative to each other to optimize cabling characteristics of the hybrid cable.

### CROSS-REFERENCE TO RELATED APPLICATION(S)

This application claims benefit to U.S. Provisional Patent Application No. 63/545,251, filed Oct. 23, 2023, the entirety of which is hereby incorporated by reference herein.

### TECHNICAL FIELD

The present disclosure relates to communication cables, and more particularly, to methods and apparatus to improve the bandwidth of such cables to enable fast upgrades to future high-speed data rates in commercial building local area networks.

### BACKGROUND

Datacenter architectures using optical fiber are evolving to meet global traffic demands and the increasing number of users and applications. The rise of cloud data centers, particularly the hyper-scale cloud, has significantly changed the enterprise IT business structure, network systems, and topologies. In this space, the use of optical fiber for transmitting communication signals has grown rapidly due to its high bandwidth, low attenuation, and other distinct advantages, including radiation immunity, small size, and lightweight.

Traditionally enterprise networks have used copper infrastructure such as unshielded twisted pair (UTP) of different levels of performance, e.g., CAT 5, CAT 6, or CAT 6 A and corresponding RJ45 connectivity specified by the Telecommunications Industry Association and Electronics Industry Association (TIA/EIA) standards.

However, copper infrastructure confines the network distances to 100 m and has reached the point where achieving power-efficient transmission at data rates beyond 10G over 100 m of the copper cable becomes challenging and, in some cases, impractical. Since the last decade, enterprise networks have been experiencing an accelerated migration from wired to wireless connections.

In the subsequent years, many businesses need to upgrade their local area networks (LAN) and campus networks to remain competitive. Currently, a considerable number of UTP networks use zone cabling (ZC). A ZC installation uses horizontal cables (HC) to connect the telecommunications room (TR) to consolidation points (CPs) located at a more convenient distance from the service devices. CPs can be placed in zone enclosures (ZE) installed on the wall, ceiling, or below the floor, providing flexibility and facilitating changes or upgrades of work area (WA) connections. Using ZC, and in particular active ZC (AZC), provides several advantages such as convergence of Information Technology (IT) data, voice networks, wireless (WiFi), and Operational Technology (OT), including lighting and security, sensor, and control devices. Also, ZC provides high flexibility for reorganizing the network for potential moves and upgrades.

It is expected that by the end of this decade, more than 95% of enterprise traffic will be carried by wireless end devices. Newer Wireless Access Points (WAP) (e.g., fully implemented Wi-Fi 7) and newer cellular bands in 5G (e.g., NR) will require extended wired high-bandwidth channels, which impose challenges to traditional copper, UTP, or coaxial media.

Optical networks can provide secure and virtually limitless bandwidth for very long distances that can cover the requirement of premises and campus networks from core to access layers. Also, due to the high bandwidth, power consumption per transmitting bit and latency are significantly lower than UTP, S-UPT, or STP channels.

Nevertheless, installing UTP today has several advantages. UTP cables may be used to connect to end devices used in enterprise LAN, for data and power transmission using Power over Ethernet (POE).

PoE provides both data connection and electrical power to end devices such as WAPs, Internet Protocol (IP) cameras, and Voice-over-Internet Protocol (VOIP) phones, small switches, sensors, OT devices, and lighting systems. Different generations of PoE have been developed by IEEE (802.3af, 802.3 at, and 802.3bt) which specify different levels of power, maximum voltages, and efficiencies.

Safer and more efficient means to transmit power than PoE have been developed recently. For example, the 2023 version of the National Electrical Code (NEC) introduced a new type of power circuit that significantly improves the transmission capacity and fault-managed future power systems, called Class 4 Power.

UTP cabling is expected to provide significant value for enterprise LANs today for data rates below 10G and a distance of 100 m. In the future, when applications require data rates >10 Gbps speed and reach >100 m (e.g., Wi-Fi 7 WAPs, 5G private cellular networks, etc.) Single Mode Fiber (SMF) or Multimode Fiber (MMF) cabling will replace UTP cabling infrastructure in LANs.

Environmental sustainability and economic reasons make it desirable to transition to fiber optic cabling for >10 Gbps applications gradually. There is no need to install the fiber until the end devices have optical ports, otherwise, media converters will add to the installation cost and the inefficiency of the network. An ideal solution would be to reuse the already installed cables that have been designed to have two operation modes. One that is fully compatible with copper twisted pairs structured cabling systems and PoE in terms of electrical, mechanical, and geometrical characteristics of the cable and connectors and another one that takes advantage of the enormous bandwidth of fiber optics. The latter operation mode can be used to provide high data rates and power when LAN end devices with embedded optical ports are available.

Here we disclose methods and apparatus to achieve fast, simple, and inexpensive LAN bandwidth upgrades, enabling virtually unlimited bandwidths (e.g., in excess of 10 Tbps) while maintaining PoE functionalities of the cable.

### SUMMARY

According to an exemplary embodiment of the present disclosure, a hybrid cable is provide, where the hybrid cable may comprise an inner core comprising a plurality of twisted pairs of conductors, said twisted pairs being each pair twisted at different pair lay lengths, optical fibers, with one or more cores fibers capable of carrying optical communications signals, a separator structure, that provide a defined separation among twisted pairs, that improve electrical properties, such as low crosstalk, and provides a central inner space, where the optical fibers are positioned and protects the fiber from tensile stress, bending and compression.

According to an exemplary embodiment of the present disclosure, a hybrid cable is provide, where the hybrid cable may comprise an inner core comprising a plurality of twisted pairs of conductors, said twisted pairs being each pair twisted at different pair lay lengths with optical fibers, with one or more cores fibers, with a separator structure, that divides the inner core into five sections, where fours twisted pair are placed in four sections of similar area, and one section contains a unit with one more optical fibers, where the separator that improves electrical properties, such as low crosstalk, and protects the fiber from tensile stress, and compression.

According to an exemplary embodiment of the present disclosure, a hybrid cable is provide, where the hybrid cable may comprise an inner core comprising a plurality of twisted pairs of conductors, said twisted pairs being each pair twisted at different pair lay lengths with optical fibers, with one or more cores fibers, where the inner core cross-section is divided into five sections, where fours twisted pair are placed in four sections, and one section contains a unit with one more optical fibers, where the unit have an insulation and strength members that protects the fiber from tensile stress, and compression.

According to an exemplary embodiment of the present disclosure, a communication cable is disclosed, the communication cable comprising an inner core comprising a plurality of twisted pairs of conductors, wherein each twisted pair of conductors includes different pair lay lengths, a separator comprising at least four segment housing areas and a central inner space, wherein at least four of the segment housing areas houses a twisted pair of conductors, and an optical fiber housed within the central inner space.

According to an exemplary embodiment of the present disclosure, a communication cable is disclosed, the communication cable comprising an inner core comprising a plurality of twisted pairs of conductors, wherein each twisted pair of conductors includes different pair lay lengths, a separator comprising at least five segment housing areas, wherein at least four of the segment housing areas houses a twisted pair of conductors, and an optical fiber housed within a fifth segment housing area.

A detailed description of this and other non-limiting exemplary embodiments of a hybrid cable and method for using such hybrid cable is set forth below together with the accompanying drawings.

### BRIEF DESCRIPTION OF THE DRAWINGS

FIG. 1A shows an exemplary cross-section view of a hybrid cable, according to a non-limiting exemplary embodiment of the present disclosure.

FIG. 1B shows an exemplary cross-section view of a hybrid cable, according to a non-limiting exemplary embodiment of the present disclosure.

FIG. 2A shows an exemplary cross-section view of a hybrid cable including measurements of certain features, according to a non-limiting exemplary embodiment of the present disclosure.

FIG. 2B shows an exemplary cross-section view of a hybrid cable including measurements of certain features, according to a non-limiting exemplary embodiment of the present disclosure.

FIG. 3 shows an exemplary graph representing the dependence of Ro and Rc for different conductor sizes, according to a non-limiting exemplary embodiment of the present disclosure.

FIG. 4A shows an enlarged view of a central inner space of the hybrid cable shown in FIG. 1B, according to a non-limiting exemplary embodiment of the present disclosure.

FIG. 4B shows exemplary cross-section views for optical fibers having different numbers of cores for the central inner space shown in FIG. 4A, according to a non-limiting exemplary embodiment of the present disclosure.

FIG. 5A shows an exemplary graph representing a total area of a strength member mapped against an amount of stress on the fiber during a fabrication phase, according to a non-limiting exemplary embodiment of the present disclosure.

FIG. 5B shows an exemplary graph representing a total area of a strength member mapped against an amount of stress on the fiber during a fabrication phase, according to a non-limiting exemplary embodiment of the present disclosure.

FIG. 5C shows an exemplary graph representing a total area of a strength member mapped against an amount of stress on the fiber during a posterior phase, according to a non-limiting exemplary embodiment of the present disclosure.

FIG. 5D shows an exemplary graph representing a total area of a strength member mapped against an amount of stress on the fiber during a posterior phase, according to a non-limiting exemplary embodiment of the present disclosure.

FIG. 6 shows an exemplary graph representing an amount of stress caused by fiber torsion as a function of the lay length for the twisted pair of conductors, according to a non-limiting exemplary embodiment of the present disclosure.

FIG. 7A shows an exemplary cross-section view of a hybrid cable, according to a non-limiting exemplary embodiment of the present disclosure.

FIG. 7B shows an exemplary enlarged view of a central inner space of the hybrid cable shown in FIG. 7A, according to a non-limiting exemplary embodiment of the present disclosure.

FIG. 7C shows exemplary cross-section views for optical fibers having different numbers of cores for the central inner space shown in FIG. 7A, according to a non-limiting exemplary embodiment of the present disclosure.

FIG. 8A shows an exemplary cross-section view of a hybrid cable, according to a non-limiting exemplary embodiment of the present disclosure.

FIG. 8B shows an exemplary cross-section view of a sub-unit included in the hybrid cable illustrated in FIG. 8A, according to a non-limiting exemplary embodiment of the present disclosure.

FIG. 9 shows an exemplary graph representing the dependence of the radius for a sub-unit and an inner core of a hybrid cable for different twisted wire conductor sizes, according to a non-limiting exemplary embodiment of the present disclosure.

FIG. 10A shows an exemplary cross-section view of a hybrid cable, according to a non-limiting exemplary embodiment of the present disclosure.

FIG. 10B shows an exemplary cross-section view of a hybrid cable, according to a non-limiting exemplary embodiment of the present disclosure.

FIG. 10C shows an exemplary cross-section view of a hybrid cable, according to a non-limiting exemplary embodiment of the present disclosure.

FIG. 10D shows an exemplary cross-section view of a hybrid cable, according to a non-limiting exemplary embodiment of the present disclosure.

FIG. 10E shows an exemplary cross-section view of a hybrid cable, according to a non-limiting exemplary embodiment of the present disclosure.

FIG. 10F shows an exemplary cross-section view of a hybrid cable, according to a non-limiting exemplary embodiment of the present disclosure.

FIG. 10G shows an exemplary cross-section view of a hybrid cable, according to a non-limiting exemplary embodiment of the present disclosure.

FIG. 10H shows an exemplary cross-section view of a hybrid cable, according to a non-limiting exemplary embodiment of the present disclosure.

FIG. 10I shows an exemplary cross-section view of a hybrid cable, according to a non-limiting exemplary embodiment of the present disclosure.

FIG. 11 shows an exemplary graph representing a curvature diameter that may be achieved for different lay lengths of the twisted wires included in a hybrid cable, according to a non-limiting exemplary embodiment of the present disclosure.

### DETAILED DESCRIPTION

Detailed non-limiting embodiments are disclosed herein. However, it is to be understood that the disclosed embodiments are merely exemplary and may take various and alternative forms. The figures are not necessarily to scale, and features may be exaggerated or minimized to show details of particular components. Therefore, specific structural and functional details disclosed herein are not to be interpreted as limiting, but merely as a representative basis for teaching one skilled in the art.

Twisted pair copper communication cable, and in particular UTP structured cabling infrastructure, is an important connection element in LAN to connect TR closets to zones, and zones to access points or end devices. As the bandwidth of devices increases, it is essential to improve achievable data rates over the cables to avoid data communication bottlenecks while providing energy to powered devices. A cable configured to achieve the required bandwidth and power transmission requirements is described here.

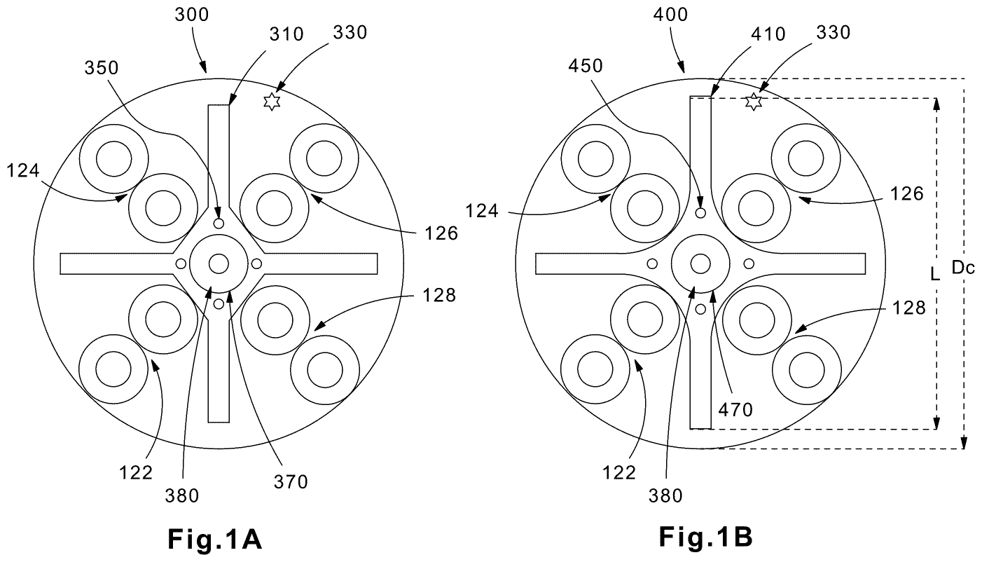

Embodiments compliant with CAT 6 or CAT 6A electrical requirements described, for example, in TIA/EIA 568 and IEC 11801, implement new inner cores 300 and 400 for a hybrid cable including both copper twisted pairs and fiber, as shown in FIG. 1A and FIG. 1B, respectively. The inner cores are surrounded by internal layers of insulation, tape(s), and a jacket. A major difference between the inner core 300 and the inner core 400 relative to the inner cores of existing known cables, are the fiber separators 310 included in the inner core 300 and the fiber separators 410 included in the inner core 400. These fiber separators 310, 410 will be referenced herein as fiber separators, incorporating a central inner space 370 or central inner space 470 that contains a glass or plastic optical fiber 380. Furthermore, the inner cores 300, 400, as well as any of the other inner cores described herein, may include a rip cord 330.

The fiber separator 310, 410, which may be manufactured by tube extrusion polymer over an optical fiber 380 with a buffer diameter from 180 to 900 microns, has four arms has a length of L. The dimensions of the separator 310, 410 are designed to minimize the total radius of the inner core 300, 400 as shown later in this disclosure.

The fiber separator 310, 410 includes one or more strength members 350, where the strength members 350 may be comprised of aramid elements, fiberglass, and/or carbon-fiber-reinforced polymers, designed to mitigate the fiber stresses on the fiber 380 which may increase attenuation and degrade the reliability of the optical channel. The fiber separator 310, 410 also protects the fiber 380 from compression forces, elongation, and excessive twists while providing a uniform separation among the twisted pairs while reducing crosstalk.

According to some embodiments, the central inner space 370, 470 may be comprised of air. In addition, or alternatively, the central inner space 370, 470 may be filled, at least in part or fully, with a soft polymer, e.g., low-density foamed polyethylene, to absorb compression forces and prevent the fiber 380 from curling. The central inner space 370, 470 may also contain strength yarns, e.g., aramid and/or water-blocking absorption yarns.

Keeping a diameter, Dc, of the inner cores 300, 400 equal or less than 5.4 mm may provide economic advantages, such as reducing the use of polymer material and reducing the occupancy fill factors in trays or conduits. For exemplary purposes, the illustrated design is configured such that Dc≤5.4 mm, considering that in other exemplary embodiments increasing the cable size from the described equations is a straightforward step.

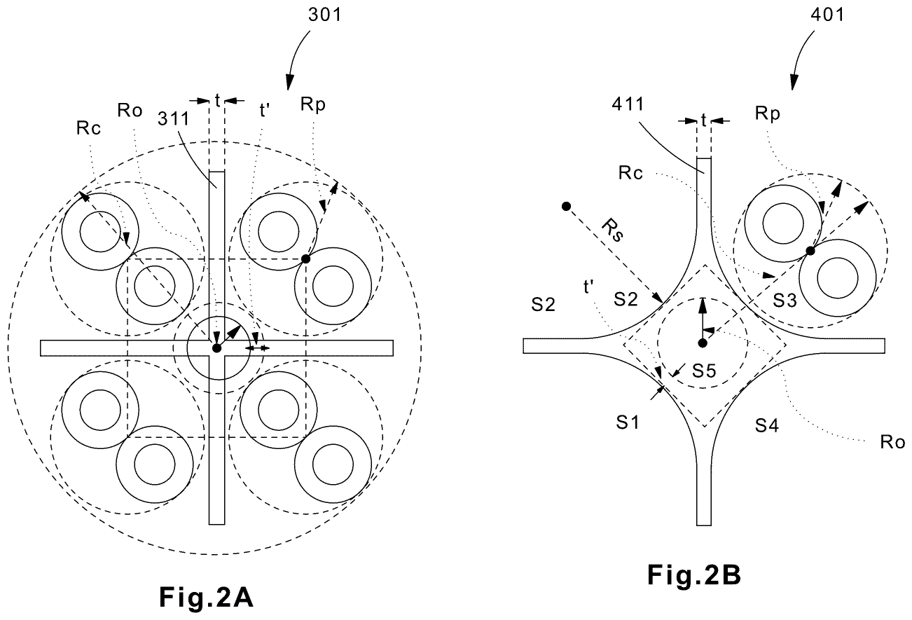

FIG. 2A shows an exemplary core 301 according to embodiments of this disclosure that includes the same general components described for cores 300, 400, such as, for example, a fiber separator 311. According to the core 301 shown in FIG. 2A, a radius of the core, Rc is set to equal 0.5×Dc, where x is the multiplication operator, and depends on the radius of the twisted pairs, Rp, and the thickness of the fiber separator, t. Assuming that the cabling length, p, is significantly larger than Rc, Rc (in FIG. 2A) may be computed as, Rc=(\sqrt{2}+1)×Rp+\sqrt{2}/2×t. Then the maximum radius, Ro, that could be allocated for optical fibers may be calculated as Ro=(\sqrt{2}−1)×Rp. These measurements may be applied to the other cores described herein.

FIG. 2B shows an exemplary core 401 that includes a fiber separator 411 that divides the inner space of the cable into five sections, where four of the segments S1, S2, S3, and S4 are of equal size and assigned to the twisted pairs 122-128, respectively. The fifth segment S5 is located in a central inner space of the fiber separator 411 and is configured to house an optical fiber. As shown in FIG. 2B, the segments S1-S4 have a radius of curvature, Rs, where Rs≥Rp when comparing the core 301 with the core 401. Note that Rs≈Rp for fiber separator 410, whereas very large values of Rs produces shapes similar to fiber separator 310. For those fiber separators, assuming t′≈t, Ro may be calculated by Ro=(\sqrt{2}−1)×(Rp+t).

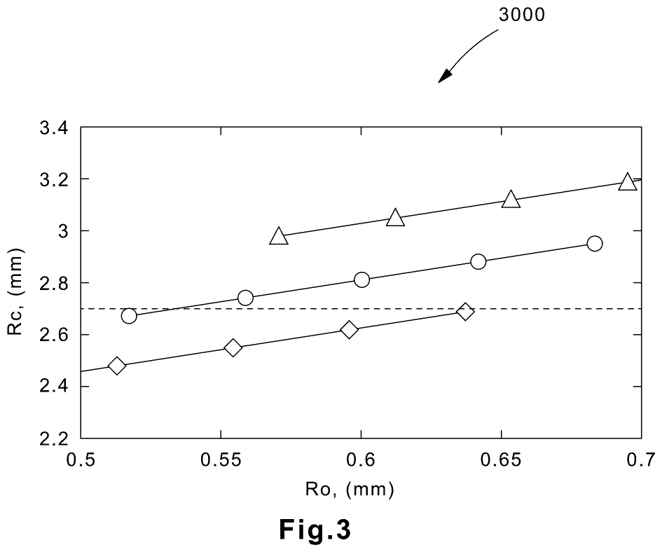

FIG. 3 shows an exemplary graph 3000 that maps the dependence of Ro and Rc for different conductor sizes, 22 AWG, 23 AWG, and 24 AWG. The radius central inner space, Ro, is plotted against a radius of the inner core, Rc, for three conductor sizes (24 AWG diamond markers, 23 AWG circle markers, 22 AWG diamond markers), where the dashed horizontal line represents an inner core desired maximum size.

The results shown in the graph 3000 indicate that for 24 AWG conductor sizes a central inner radius in the range of 0.45<Ro<0.64 mm may be obtained while keeping Rc<2.7 mm (for an inner core diameter of 5.4 mm). For 23 AWG conductor sizes a central inner radius Ro up to 0.53 mm may be obtained while keeping Rc<2.7 mm. Accommodating 23 AWG or 22 AWG sized conductors may be possible with a slightly larger cable inner core (>5.4 mm).

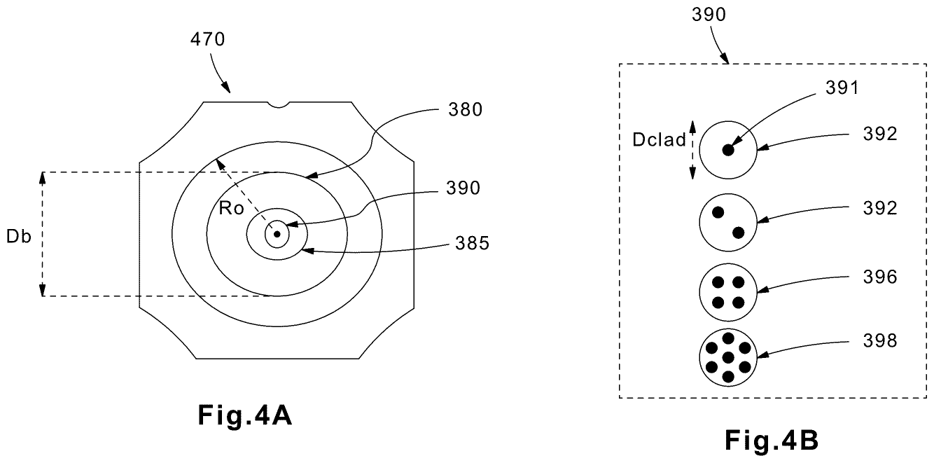

FIG. 4A shows an enlarged view of the central inner space 470, where the central inner space 470 includes one fiber 380, with cladding 390, and primary coatings 385, e.g., UV-cured acrylate polymer coatings. The diameters of the optical fiber cladding 390 are between 110 to 135 microns, where ˜125 microns may be considered a typical diameter used for optical communication. The outer diameter of the primary coatings typically ranges from ˜180 to ˜250 microns. Due to additional layers to protect the fiber, the outer diameter of the optical fiber 380, Db, ranges between 200 to 900 microns. The number of fibers that may be placed in the central inner space 470 depends on the ratio of 4(Ro/Db)² where Db<2×Ro.

FIG. 4B shows exemplary fibers, where optical fibers with more than one core, e.g., multicore fibers (MCF), are shown to be usable in an inner space 470 (or 370) of a core 400 (or 300). So, FIG. 4B shows a cross-sectional view of cladding 390 and core 391 for different types of optical fibers 380. For example, a fiber with one core 392, two cores 394, four cores 396, and seven cores 398 are shown in FIG. 4B.

Although the glass optical fibers may be very strong, e.g., 400 KPSI and 800 KPSI, glass defects may cause cracks and fractures when large stresses are applied to the fiber. The stress may be produced by different causes such as tension, bending, or torsion. The maximum tolerable stress may be given by

$$σmax = \frac{σ o}{f} ,$$

where σo≈1600 kg/mm² and f is a safety factor >1. In one or more of the disclosed embodiments, the strength members 350, 450 of the central inner space 370, 470, may limit the fiber stress to values significantly lower than the fiber proof test, ˜690 MPa, (˜ 70.3 kg/mm²).

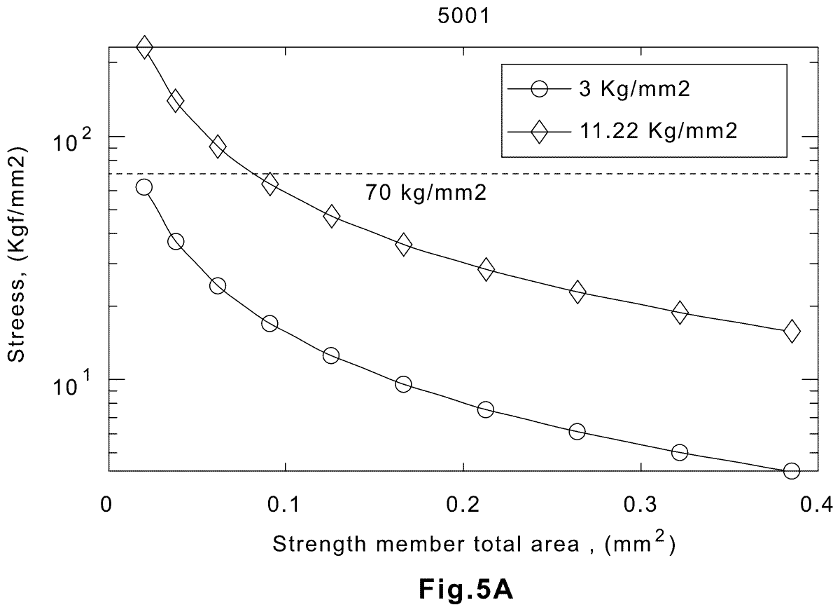

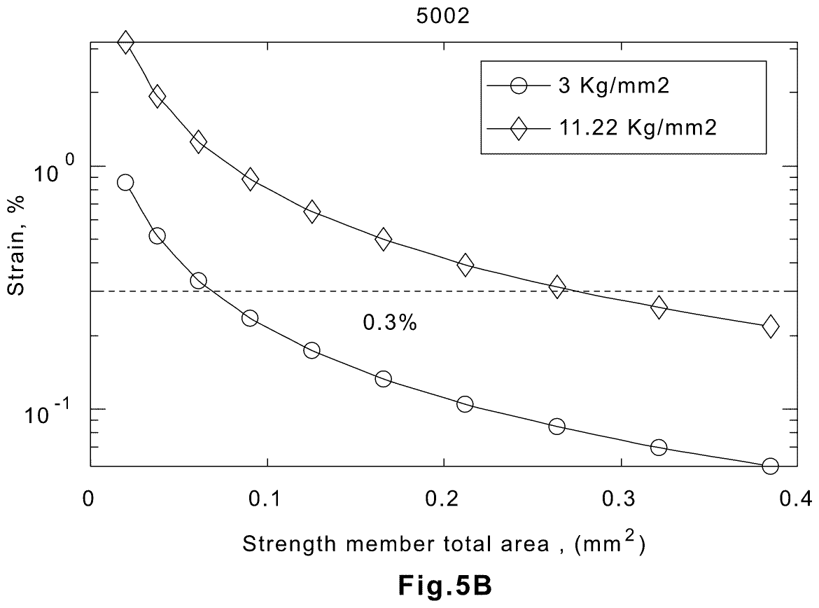

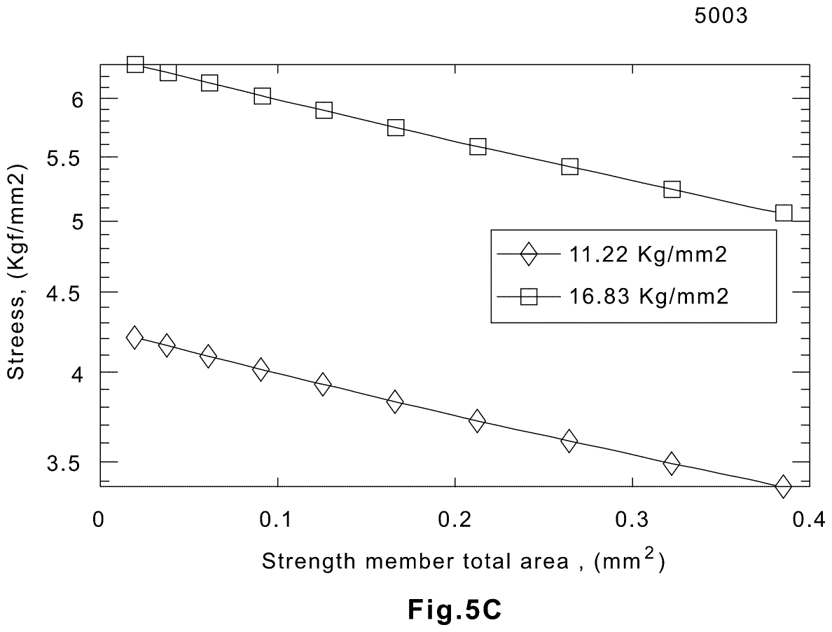

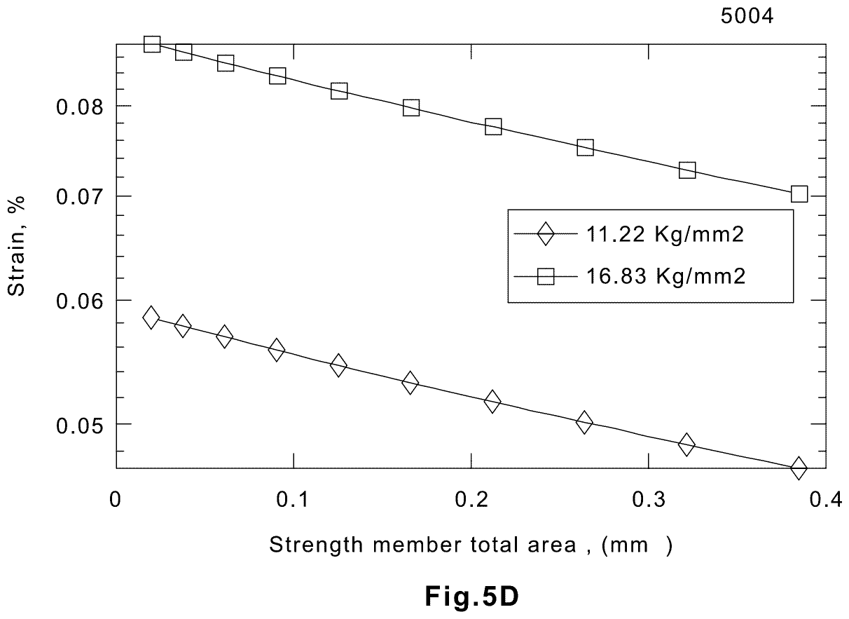

FIGS. 5A-5D show different graphs 5001, 5002, 5003, 5004 that represent the stress and strain on a fiber, in two production phases of the inner cores 300, 400, across a total area (mm²). For instance, in FIG. 5A the horizontal axis of the graph 5001 represents the total area of the strength members in units of mm² (e.g., as distributed in the four sections shown in FIGS. 1A and 1B), and the vertical axis represents the stress on the fiber in kg/mm². In FIG. 5B the vertical axis of the graph 5002 represents the strain on the fiber in a percentage (%) format, while the horizontal axis represents the total area of the strength members in units of mm². The graphs 5001 and 5002 shown in FIGS. 5A-5B depict the stress in the fiber during the fabrication phase of the fiber separator 310 or 410 for two pulling forces assuming Kevlar yarns with Young module 13000 kg/mm².

After the first production phase, e.g., single or double extrusion of the fiber separator over the optical fiber(s), the strength members are designed to constrain fiber strains to less than 0.3% and the fiber stresses to less than 20 kg/mm². This design places all the strength of the fiber separator 310 or 410 on the strength members neglecting the polymer which has a relatively small Young modulus.

The first pulling force, of about 11.22 kg (diamond markers), is the recommended maximum pull force for UTP cables. Using this force, it may be estimated that the total area of the support members should be at least 0.3 mm² to keep tensions below 20 kg/mm² and strains below 0.3%. The second pulling force of about 3 kg (circle markers) requires that the total area of the support members should be at least 0.1 mm² to keep tensions below 20 kg/mm² and strains below 0.3%. This result indicates a cost-efficient construction of the fiber separator 310 or 410 it is possible for areas around 0.1 to 0.2 mm² when the pulling forces during the fabrication of the fiber separators are maintained below 6 kg.

Also evaluated are the fiber stress and strain that may occur during a posterior production stage, the cabling represented in graph 5003 and 5004 shown in FIGS. 5C-5D are for two pulling forces. Similar results shown in the figures may be used to estimate the stress during the deployment of the cable. The first pulling force is the recommended maximum pull force for UTP cables, ˜11.22 kg (represented by the diamond markers in FIGS. 5C-5D), and the second evaluates the effect of a force 50% higher, 16.83 kg, (represented by the square markers in FIGS. 5C-5D). The results shown in graphs 5003 and 5004 indicate that even using a force 50% higher than the recommended pulling force, the stress and strain are significant for strength member 350 or 450 with areas around 0.1 mm, since the eight copper twisted pairs help to keep tensions low. Further analysis using the same equations indicates that the cable pulling forces may be increased four times the recommended maximum, of 11.22 kg, while maintaining, tensions below 20 kg/mm² and strains below 0.3%.

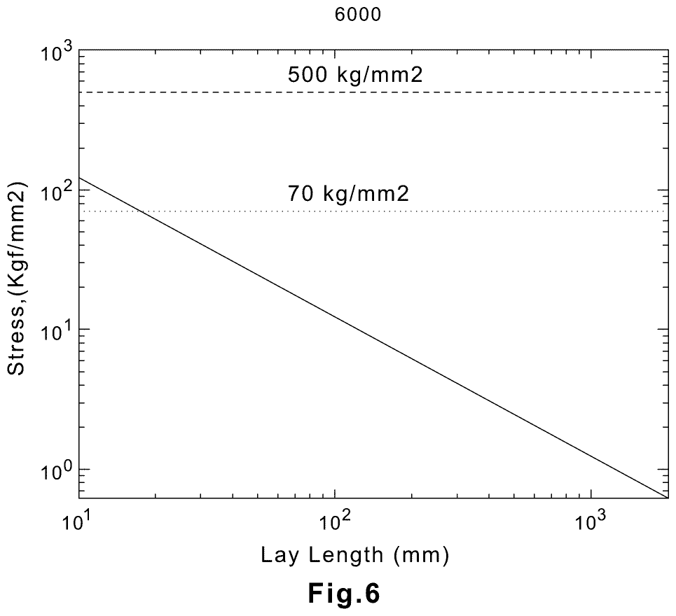

Another source of fiber stress produced during the cabling process is torsion. FIG. 6 shows a graph 6000 that represents an evaluation of the stress caused by the fiber torsion as a function of the cabling lay. The graph 6000 shows that stress in the fiber below 20 kg/mm² may be achieved by keeping p≥90 mm. Shorter lengths as short as p˜60 mm, may require applying some degree of pre-twist to the fiber 380, during the manufacturing of the fiber separator 310 or 410.

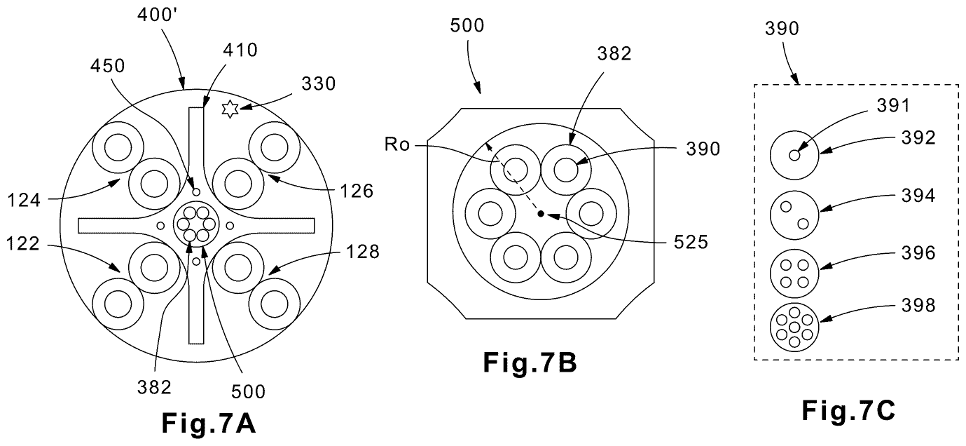

FIG. 7A shows another embodiment of an inner core 400′, with a central inner space 500 that contains more than one optical fiber 382. FIG. 7B shows a magnified view of the central inner space 500 that displays an estimated range of a maximum radius, Ro, (shown previously in FIG. 2B) that allows placing up to six optical fibers 382 around a central strength member 525. In this embodiment shown in FIGS. 7A-7C, each of the optical fibers 382 has a diameter between 200 to 400 microns and may have one or more cores 391 inside the cores 392 (single core), 394 (two cores), 396 (four cores), or 398 (seven cores) as shown in FIG. 7C. For example, the optical fiber 382 may include a single core (SMF), or multi-cores (MMF), within the central inner space 500.

As shown in FIGS. 7A-7C, these optical fibers 382 may be helicoidal stranded on a reinforcement element, a central strength member 525 which may be comprised of aramid yarns, fiberglass, or carbon-fiber-reinforced polymers. Using the central strength member 525, and proper design of Ro of any elongation of the fiber separator 410 produces a fiber movement inside the tube structure, preventing or reducing stress in the optical fibers 382.

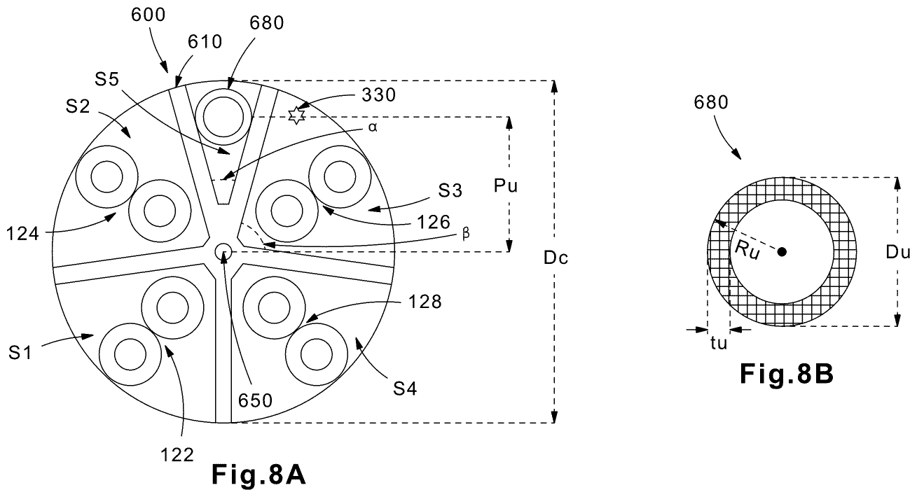

The inner core 600 of another embodiment is shown in FIG. 8A. This embodiment uses a fiber separator 610 which divides the inner core 600 into five segments, where segments S1, S2, S3, and S4 are sections with a similar cross-sectional area assigned to the twisted pairs 122, 124, 126, and 128, respectively. The subtended angle between the arms of the fiber separator 610, angles β, are identical for segments S1, S2, S3, and S4. Segment S5 includes subunit 680, a circular polymer tube that houses one or more optical fibers inside its body. It is assumed here that the subunit 680 has a circular shape, with radius Ru and outer diameter Du=2×Ru as shown in FIG. 8B.

The fiber separator 610 may have a central strength member 650 consisting of aramid yarns, fiberglass, carbon-fiber-reinforced polymers, or small gauge metal wires. Element 655 is an optional element to increase the strength of the separator and reduce the compression forces on the subunit 680.

A proper design of the angles α, β, and the thickness of the fiber separator 610 is required to keep the inner core diameter Dc below a predetermined measurement such as, for example, 6.2 mm. The angle α for the segment S5 may be less than the angle β for the other segments S1, S2, S3, S4 created by the separator 610. The relationship between the diameter of the subunit 680 and α is given by,

$$sin ( \frac{α}{2} ) = ( Ru + t / 2 ) / Pu ,$$

where Pu is the radial distance from the center of the subunit 680 to the center of the fiber separator 610, and t is the thickness of the arms of the fiber separator 610. The relationship between Rp and β is given by

$$sin ( \frac{β}{2} ) = ( Rp + t / 2 ) / Pp$$

where Pp is the radial distance of the center of the twisted pairs 122, 124, 126, or 128 to the center of the fiber separator 610.

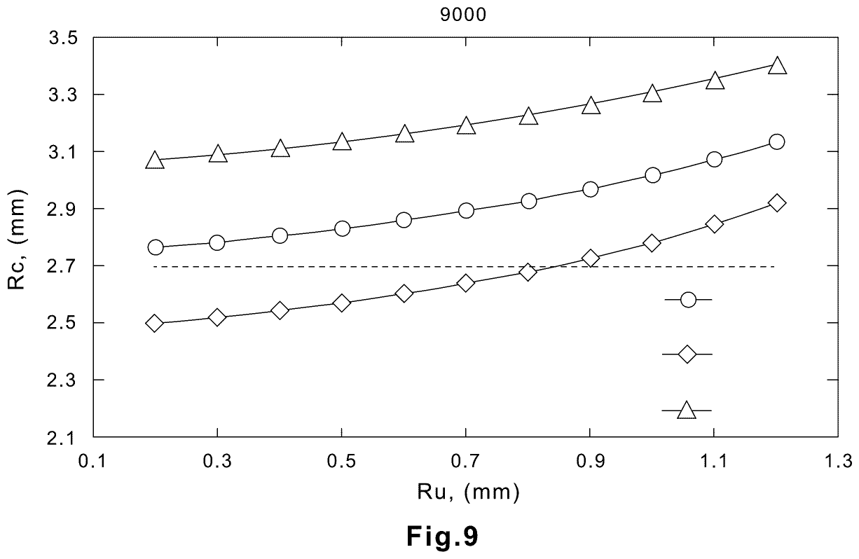

Based on the previous embodiment shown in FIGS. 8A-8B, FIG. 9 shows a graph 9000 representing the dependence of Ru and Rc for a range of subunit 680 sizes and twisted pairs 122, 124, 126, and 128 having different conductor sizes, 22 AWG, 23 AWG, and 24 AWG. According to the results shown in the graph 9000, it would indicate that using twisted pair with conductors equal to or smaller than 24 AWG, may accommodate subunits 680 with a radius up to Ru≤0.8 mm while keeping Rc<2.7 mm. Assuming a subunit 680 with Ru=1.1 mm and insulation layer tu=0.3 mm, a cross-sectional space with a radius up to 0.8 mm may be used to accommodate one or more fibers. Larger conductor sizes, e.g., 23 AWG or 22 AWG may be used for cables with larger inner core diameters (Rc>2.7 mm) enabling subunits with Ru>0.8 mm as represented in the graph 9000 of FIG. 9.

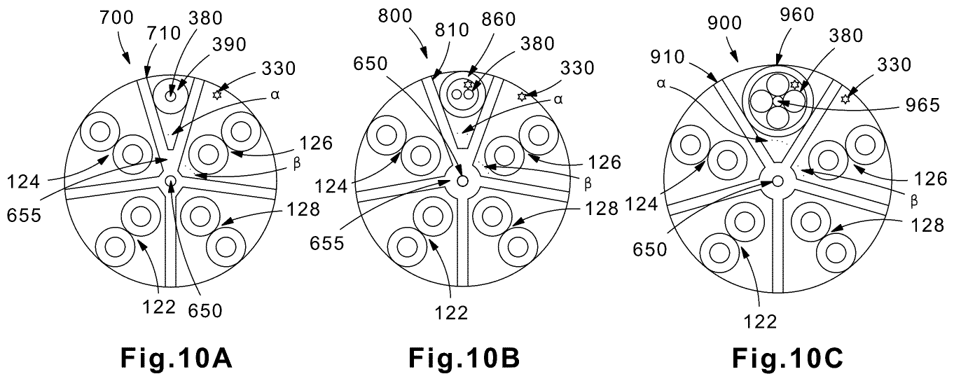

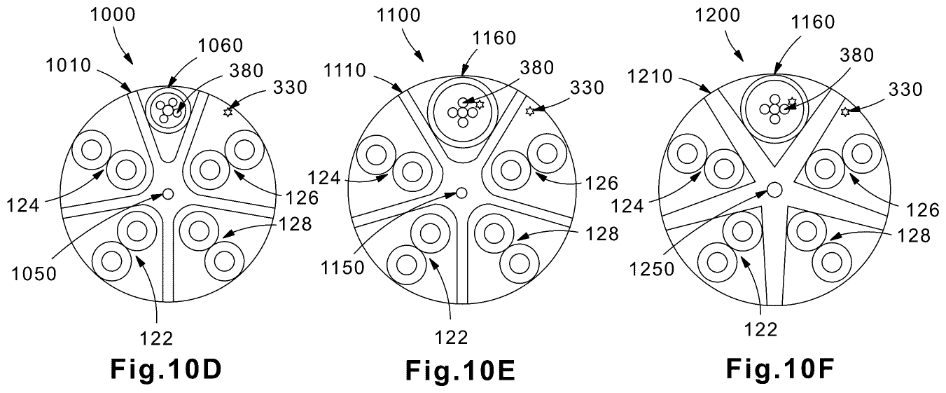

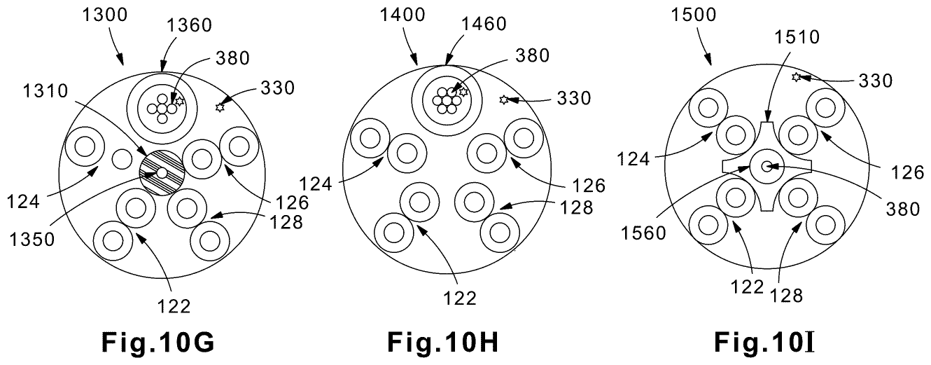

FIGS. 10A-10I shows different embodiments of inner core designs that may be included in the inner space of the hybrid cables disclosed herein. For example, the embodiments shown in FIGS. 10A-10C are modifications to the design of subunit 680 shown in FIG. 8A with optical fibers of diverse diameters, with one, two, and four fibers. For example, FIG. 10A shows an inner core 700 having a fiber 380 (e.g., 900-micron diameter fiber) housed within its own segment created by a separator 710, instead of being housed within the subunit 680 of the inner core 600 illustrated in FIG. 8A.

In FIG. 10B the inner core 800 includes a subunit 860 having a Du=1.2 mm diameter and depending Rc<2.9 mm. Assuming tu=0.2 mm, the subunit 860 internal radius is Ru−tu=0.4 mm which allows for at least two fibers 380 with 250-micron diameter each to be housed within the subunit 860. These optical fibers 380 may be stranded on a reinforcement element (not shown in the figure). Increasing the radius of the subunit 860 may provide space for more fibers or fibers with larger buffers, which provide more mechanical protection.

In FIG. 10C the inner core 900 includes a subunit 960 with a Du=1.85 mm diameter which is close to the diameter of a twisted pair with a conductor size of 24 AWG. From the graph 9000 shown in FIG. 9, it may be shown that using Ru=0.925 mm, and twisted pairs 122, 124, 126, and 128 respectively of 24 AWG conductor size, Rc<2.8 mm may be achieved. By increasing the conductor size to 23 AWG conductor size, Rc<3 mm may be achieved.

Assuming tu=0.2 mm, the subunit 960 internal radius may be calculated to be Ru−tu=0.725 mm which allows for at least four optical fibers 380 with up to 600-micron diameter each to be housed within the subunit 960. As shown in the figures, these optical fibers may be helicoidal stranded on a reinforcement element, a central strength member 650 which may consist of aramid yarns, fiberglass, or carbon-fiber-reinforced polymers. Using the central strength member 650, any elongation of the subunit 960 produces a fiber movement inside the tube structure, preventing or reducing stress in the optical fibers 380.

As shown in FIGS. 10A-10C, the angles α and β of the embodiments of the inner cores 700, 800, and 900 depending on the ratio Ru/Rp. The smaller the ratio, for example when comparing the inner cores shown in the embodiments of FIG. 10A to FIG. 10C, the smaller the value of α. To summarize, α700<α800<α900, since the Ru/Rp ratio of the radius of the inner core 900 shown in FIG. 10C is larger than the radius of the inner core 800 shown in FIG. 10B, and the radius of the inner core 800 shown in FIG. 10B is larger than the radius of the inner core 700 shown in FIG. 10A.

FIGS. 10D-10F show embodiments of inner cores 1000, 1100, and 1200 which use fiber separators 1010, 1110, and 1210, and strength members 1050, 1150, and 1250, respectively. The embodiments of the inner cores 1000, 1100, and 1200 may provide a stronger structure, e.g., see the connection among arms of the separator, at the cost of using more polymer.

In FIG. 10D, the inner core 1000 includes the separator 1010 that creates five segments, where one of the segment is dedicated to including a subunit 1060 for housing one or more fibers 380, while the remaining four segments include their own dedicated twisted pair of conductors 122, 124, 126, 128.

In FIG. 10E, the inner core 1100 includes the separator 1110 that creates five segments, where one of the segment is dedicated to including a subunit 1160 for housing one or more fibers 380, while the remaining four segments include their own dedicated twisted pair of conductors 122, 124, 126, 128. The subunit 1160 is larger than the subunit 1060, which in turn results in the segment holding the subunit 1160 to be larger than the subunit holding the subunit 1060. The larger size of the subunit 1160 may allow for the inclusion of its own rip cord 330.

In FIG. 10F, the inner core 1200 includes the separator 1210 that creates five segments, where one of the segment is dedicated to including the subunit 1160 for housing one or more fibers 380, while the remaining four segments include their own dedicated twisted pair of conductors 122, 124, 126, 128. The separator 1210 is shown to be more robust than the separators 1010, 1110, which may result in the segment areas formed by the separator 1210 to be smaller than the segment areas formed by the separators 1010, 1110.

FIG. 10G shows an embodiment of an inner core 1300 including a central cylindric separator 1310 of radius ˜0.68 mm, and a subunit 1360 for housing one or more fibers 380. The separator 1310 includes a strength member 1350. When Ru/Rp≈1, a smaller diameter for the separators is required.

FIG. 10H shows an embodiment of an inner core 1400 without any separator. Instead, a subunit 1460 is included within the inner core 1400 for housing one or more fibers 380. Without the separator, the subunit 1460 may be larger for housing more fibers 380, or alternatively, larger diameter fibers 380.

FIG. 10I shows an embodiment of an inner core 1500 that is an example of a hybrid cable with a central separator 1510 that includes a central inner space 1560 for housing one or more fibers 380 inside. This configuration of the inner core 1500 and the separator 1510 may provide a small cable diameter and use less polymer than previous embodiments.

The shape of the separators for inner cores have numerous degrees of freedom and only some of them are shown in FIGS. 10A-10F. For example, symmetric shapes may in general represented in polar coordinates by:

$$Rsep = Real ( ( max ( abs ( Rc \times cos ( 5 x υ ) ) , 0.1 Rc ) \times sgn ( ( Rc \times cos ( Mx υ ) ) ) \hat{} e ) )$$

where ϑ is an angle between 0 and 2×pi, Real is a function that returns the real part of the argument, sgn is the sign function, e is an arbitrary real number exponent positive or negative and M takes a value of 2, 2.5, 4 or 5.

In the previous embodiments, the crosstalk among twisted pairs may be further improved by placing the worst crosstalk pair combination (from the twisted pairs 122, 124, 126, or 128), in segments S2 and S3. For example, in the embodiments shown in FIGS. 10A-10I it may be assumed that the worst crosstalk occurs between pairs 124 and 126.

As shown previously (e.g., graph 6000 shown in FIG. 6), depending on the cabling lay used when producing the inner core, e.g, embodiments of the inner cores 600, 700, 800, 900, 1000, 1100, or 1200, some degree of back twisting may be applied to the payoff reel of subunits 860, 960, 1060, 1160, or 1260 to minimize the torsion stress in the fibers.

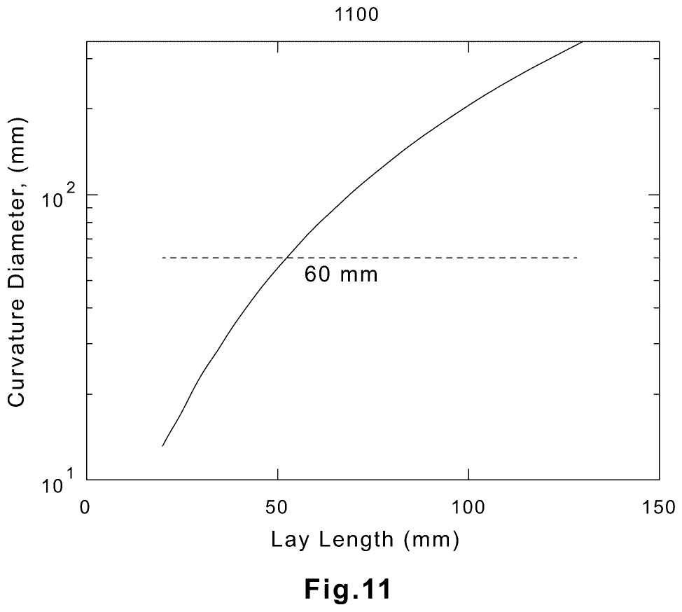

The fiber inside subunits 860, 960, 1060, 1160, or 1260 may be stranded around a center member to compensate for elongation caused during pulling or contraction due to thermal. An excess fiber percentage, ε, defined as,

$$ε = \frac{Lf - Lt}{f} \times 100 \% ,$$

where Lf is the fiber length given by and Lf=(p²+4×π×r²), where r=Rc−Db/2. The larger E, the larger the buffer to absorb length variations, however, it may reduce the bend radius of the fiber. In the disclosed embodiments, the target is a fiber bending with a minimum diameter of curvature of 60 mm. The graph 1100 in FIG. 11 shows that for p>60 mm radius of curvature greater than 60 mm may be achieved.

Communication cables using the disclosed inner core embodiments may provide versatile and future-proof networks. For example, the communication cables may operate at data rates of 1 Gbps, 2.5 Gbps, 5 Gbps, or 10 Gbps over copper twisted pair media, while providing power, e.g., PoE. In one installation, these cables also carry optical fiber elements. The inner cores embodiments disclosed serve to provide high-performance twisted pair communication cables, with uniform structure, and low crosstalk with diameters very similar to current twisted pair cables, e.g., UTP cables. The designed elements of the inner cores 300, 301, 400, 401, 700, 800, 900, 1000, 1100, 1200, 900, 1300, 1400, and 1500 were designed to minimize the overall diameter of the cable while minimizing tensile, bending, or rotational stresses in the fibers. Therefore, communication cables using the disclosed inner cores may be packaged in boxes with reels, or without reels, e.g., using figure-eight coils.

Communication cables with the disclosed inner core embodiments will enable, fast and inexpensive upgrades, where the fiber could be terminated fusion splicing pigtails, using splice-on connectors, or mechanical splice such as Panduit Corp.'s OptiCam connectors. The latter will provide a very fast termination, tens of seconds, with the advantage of using an inexpensive tool, without requiring a technician trained in fusion splicing while providing accurate measurements of insertion loss of the connector. Alternatively, the optical fiber may be factory terminated in LC, mini LC, SC, or other optical fiber connectors, so the user only needs to terminate the copper connections with RJ-45. In other cases, the optical fiber may be terminated in 2.5 mm or 1.25 mm pre-polished ferrule and protected in a sealed polymer that may be removed when needed. When needed, the installer may remove the protecting polymer and put the ferrule in a housing.

When edge devices and/or such access points are capable of operating with optical transceivers, there may be no need to decommission the cables and install new ones to improve bandwidth. Once the fiber is terminated with the connector, the twisted copper wires may be used to transport energy, DC, or Class 4 power. The latter may be achieved by providing jacked, insulation, prepared to withstand 450 V peak voltage.

Even using a fraction of that cable capacity, e.g., 200V and 0.5 A per wire, a four-pair cable with the disclosed inner core should be able to transmit 400 W of power, which may be enough to power active zones and end several end devices connected to it. For very high efficiency and low transmission losses, the current might be reduced to 0.25 A per wire, which enables transmission of 200 W per cable.

Cables with embodiments of the inner core 300, 301, 400, 401, 700, 800, 900, 1000, 1100, 1200, 900, 1300, 1400, and 1500 may be implemented with one, two, or more fibers as shown in this disclosure. In many cases using only one fiber is enough to deploy passive optical networks (PON) and distributed antenna systems. Using wavelength division multiplexing, in particular, Coarse WDM (CWDM) or a similar method, one fiber may transmit simultaneously different PON generations and Ethernet traffic over the same fibers. The advantage of using CWDM passive multiplexers and demultiplexers (MUX and DEMUX) is the low loss of the devices (<1.5 dB) and the low cost of transceivers since the laser wavelength is allowed to change in a wide spectral window compared to WDM. CWDM may use up to 18 wavelengths or channels each with current speeds up to 25 Gbps. 50 Gbps is already available for a few of those channels. Higher data rates, 100 Gbps BiDi, being developed for Metro applications in IEEE standard organizations may be used in the future, when cost reduces due to volume, in enterprise networks.

Therefore, today low-cost CWDM at aggregated data rates of 180 Gbps (18×10 Gbps) and 450 Gbps (18×25 Gbps) per duplex fiber is available at a relatively low cost. Combining CWDM channels with Ethernet channels over 1 Tbps may be achieved today in a SMF duplex pair. Also, an arrangement of optical filter devices (multiplexer and demultiplexer), may convert standard duplex channels to bidirectional, enabling transmitting and reception over one fiber.

Embodiments that use MCF instead of SMF may have significantly more bandwidth (e.g., 4X more than values previously mentioned) in a very small footprint cable, almost identical to a standard UTP cable without the fibers.

Table I below shows use cases of cables with the different disclosed embodiments of the compact inner cores 300, 301, 400, 401, 700, 800, 900, 1000, 1100, 1200, 900, 1300, 1400, or 1500 along the lifetime of the cable. Additional advantages of using the disclosed cable and method relate to avoiding or minimizing disruptions due to frequent re-cabling, (removing cable may damage adjacent ones), and extending the lifecycles for infrastructure which reduces capital expenses. Also, the compact diameters of cables providing data and highly efficient power, e.g., Class 4 power, avoid using large diameter composite cables, which could negatively impact airflow or use of space.

TABLE I

| | Immediate use after | Near/mid-term after | Mid/long term after |
|---|---|---|---|
| Use case | deployed | deployed | deployed |
| 1- A cable with any | Use copper conductors to | Use fiber, terminated with LC | Use fiber, terminated with |
| of the disclosed inner | transmit data and limited | or SC connector using an | LC or SC and CWDM |
| cores with only one | power. For example, use | optical tool or splice-on | MUX/DEMUX to expand up |
| SMF. (Inner core | 10GBASE-T, and 60 W | connectors to transmit | to 9 bidirectional channels |
| diameter <2.6 mm) | PoE for 100 m of cable. | bidirectional signals, e.g., | each operating at 1 Gbps, |
| | Connect PoE switch and | XGS-PON. Use copper | 10 Gbps, 25 Gbps, or |
| | end devices using RJ-45 | conductors to transmit DC | 100 Gbps. Use copper |
| | connector. | power | conductors to transmit Class |
| | | | 4 power with 400 W (200 V, |
| | | | 0.5 A) per cable. |
| 2- A cable with any | Use copper conductors to | Use fibers, terminated with | Use CWDM MUX/DEMUX |
| of the disclosed inner | transmit data and limited | LC, SC, SN, MDC, or MPO | to expand up to 18 channels |
| cores with N > 1 | power. For example, use | connectors using an optical | each operating at 1 Gbps, |
| SMFs. (Inner Core | 10GBASE-T, and 60 W | tool (for LC or SC) or splice- | 10 Gbps, 25 Gbps, or |
| diameter <2.8 mm) | PoE for 100 m of cable. | on connectors to transmit | 100 Gbps, enabling >1 Tbps. |
| | Connect PoE switch and | unidirectional or bidirectional | Use copper conductors to |
| | end devices using RJ-45 | signals, use copper | transmit Class 4 power, e.g., |
| | connector. | conductors to transmit DC | 200 W (200 V, 0.25 A) or |
| | | power | 400 W (200 V, 0.5 A) per |
| | | | cable. |
| 3- A cable with any | Use copper conductors to | Use fiber, terminated with LC | Use CWDM MUX/DEMUX |
| of the disclosed inner | transmit data and limited | or SC connector using multi- | to expand up to 18 channels |
| cores with 1 MCF. | power. For example, use | core splicers to transmit | per core. enabling >1 Tbps |
| (Inner Core | 10GBASE-T, and 60 W | duplex unidirectional signals, | per MCF. Use copper |
| diameter <2.6 mm) | PoE for 100 m of cable. | e.g., 200GBASE-DR2 or 2x | conductors to transmit Class |
| | Connect PoE switch and | 400GBASE-FR4. | 4 power, e.g., 200 W (200 V, |
| | end devices using RJ-45 | | 0.25 A) or 400 W (200 V, 0.5 |
| | connector. | | A) per cable. |
| 4- Include the cases | As described in previous | Optics ready to install | Combine CWDM with |
| described above with | options | enabling data rates mentioned | Ethernet to achieve >1 Tbps |
| pre-terminated | | above | per duplex SMF or one MCF. |
| optical connector | | | |

As is readily apparent from the foregoing, various non-limiting exemplary embodiments of a hybrid cable have been described. While various embodiments have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the following claims.

What is claimed is:

1. A communication cable comprising:
an inner core comprising:
a plurality of twisted pairs of conductors, wherein each twisted pair of conductors includes different pair lay lengths;
a separator comprising at least four segment housing areas and a central inner space, wherein at least four of the segment housing areas houses a twisted pair of conductors; and
an optical fiber housed within the central inner space.

2. The communication cable of claim 1, wherein the optical fiber includes one or more core fibers configured to transmit optical communications signals.

3. The communication cable of claim 1, wherein the optical fiber is a multimode fiber with a buffer diameter between 0.25 mm and 0.9 mm.

4. The communication cable of claim 1, wherein the optical fiber is a single mode fiber with a buffer diameter between 0.25 mm and 0.9 mm.

5. The communication cable of claim 1, wherein the separator further comprises at least one strength member.

6. The communication cable of claim 5, wherein the at least one strength member is located in an area of the separator that is less than or equal to 0.3 square millimeters.

7. The communication cable of claim 1, wherein the separator contains semiconductor material to improve an electrical property of the cable.

8. The communication cable of claim 1, wherein the separator is configured in a symmetric shape that includes four segment housing areas, each of the four segment housing areas configured to house a twisted pair of conductors.

9. The communication cable of claim 1, wherein the twisted pair of conductors are sized to include and be between 22 AWG to 26 AWG.

10. The communication cable of claim 1, wherein each twisted pair of conductors is configured to transmit a power signal having voltages of up to 400V and currents up to 0.5 A per wire.

11. The communication cable of claim 1, wherein a diameter of the inner core is less than 2.7 mm.

12. The communication cable of claim 1, wherein the separator comprises a fifth segment housing area configured to house one more optical fibers.

13. The communication cable of claim 12, wherein the fifth segment housing includes a subunit configured to house the one or more optical fibers, and wherein the subunit comprises a circular tube with insulation thickness and strength members that protect the one or more optical fibers housed inside the subunit.

14. The communication cable of claim 1, wherein the optical fiber is terminated with one of a fusion splicing pigtail or splice-on connector.

15. The communication cable of claim 1, wherein the optical fiber is factory pre-terminated.

16. A communication cable comprising:
an inner core comprising:
a plurality of twisted pairs of conductors, wherein each twisted pair of conductors includes different pair lay lengths;
a separator comprising at least five segment housing areas, wherein at least four of the segment housing areas houses a twisted pair of conductors; and
an optical fiber housed within a fifth segment housing area.

17. The communication cable of claim 16, the separator further comprising a subunit inside the fifth segment housing area, the subunit housing the optical fiber.
